(19) United States
(12) Patent Application Publication
(10) Pub. No.: US 2024/0236013 A1
(43) Pub. Date: Jul. 11, 2024

(54) COMMUNICATION DEVICE, SCHEDULING METHOD, AND PROGRAM

(71) Applicant: NIPPON TELEGRAPH AND TELEPHONE CORPORATION, Tokyo (JP)

(72) Inventors: Ryohei TSUGAMI, Musashino-shi, Tokyo (JP); Tatsuya FUKUI, Musashino-shi, Tokyo (JP)

(73) Assignee: NIPPON TELEGRAPH AND TELEPHONE CORPORATION, Tokyo (JP)

(21) Appl. No.: 18/572,168

(22) PCT Filed: Jul. 9, 2021
(86) PCT No.: PCT/JP2021/025993

§ 371 Date: Dec. 19, 2023

(51) Int. Cl. H04L 47/625; H04L 47/24

(52) U.S. Cl. CPC H04L 47/6255; H04L 47/24

(57) ABSTRACT

Objects of the present invention are to provide a communication apparatus, a scheduling method, and a program which can inhibit a buffer overflow, even in a state where inflow traffic to each of a plurality of queues changes from moment to moment.

A communication apparatus according to the present invention includes: a remaining queue length monitoring unit 14 that acquires queue lengths of a plurality of queues 13; an inflow amount monitoring unit 15 that acquires a data inflow amount to each of the queues 13; and a controller 17 that calculates a remaining time until a buffer overflow from the queue lengths and the data inflow amount for each of the queues 13, computes a reciprocal ratio of the remaining time for each of the queues 13, and determines that a product of the ratio and an amount of data per unit time which can be output from an output unit 11 is a data output amount of each of the queues 13.

### TECHNICAL FIELD

The present disclosure relates to a communication apparatus, a scheduling method, and a program which use quality of service (QOS).

### BACKGROUND ART

The wide spread of the Internet of things (IOT) and remote work is resulting in a continuous increase in communication traffic year after year. As one method of efficiently dealing with the continuously increasing traffic, QOS, which involves performing scheduling of packets depending on characteristics of application software, is used in communication networks. Various QoS algorithms are used to satisfy conditions of delay or bandwidth. In the case of a plurality of queues, round-robin scheduling is used; however, a method for allocating equal transmission opportunities to all of the queues is often employed.

For example, Patent Literature 1 discloses a rate control method for dynamically controlling allocation of a bandwidth for input traffic having preset quality of service. The corresponding method deals with an increase in traffic by setting a threshold value for queues, decreasing a transmission rate of a queue having a priority other than a high priority when a queue having the high priority exceeds the set threshold value, and increasing a transmission rate of the queue having the high priority. In the corresponding method, a transmission rate of a queue in a class having an increase in traffic is increased, and thereby, quality deterioration due to a delay in the corresponding class is inhibited.

### CITATION LIST

### Patent Literature

Patent Literature 1: JP 2002-344509 A

### SUMMARY OF INVENTION

### Technical Problem

The technology of Patent Literature 1 can inhibit quality deterioration due to a delay by increasing a transmission rate of a specific queue and can also inhibit packet loss due to a buffer overflow. However, the technology of Patent Literature 1 has a problem in that the packet loss or the buffer overflow in another queue is difficult to inhibit, since a transmission rate of the other queue is decreased.

In addition, the technology of Patent Literature 1 also has a problem in that a risk of the buffer overflow is difficult to accurately predict, since an amount of packets accumulated in a queue is monitored to control a transmission rate, but a packet inflow amount to the queue is not reflected.

Specifically, when a state where a small amount of packets is accumulated in a queue, but a packet inflow amount to the queue rapidly increases, is compared with a state where a large amount of packets is accumulated in a queue, but a packet inflow amount to the queue is small, the former is considered to have a higher risk of the buffer overflow. However, a high possibility of the buffer overflow in the former is difficult to predict only by monitoring the amount of packets accumulated in a queue.

In this respect, in order to solve the problems described above, objects of the present invention are to provide a communication apparatus, a scheduling method, and a program which can inhibit a buffer overflow, even in a state where inflow traffic to each of a plurality of queues changes from moment to moment.

### Solution to Problem

In order to achieve the objects described above, the scheduling method according to the present invention is performed by monitoring both an amount of packets accumulated in a queue and a packet inflow amount to the queue and determining an output amount from each queue based on the two observed amounts.

Specifically, a communication apparatus according to the present invention includes:
a remaining queue length monitoring unit that acquires queue lengths of a plurality of queues;
an inflow amount monitoring unit that acquires a data inflow amount to each of the queues; and
a controller that calculates a remaining time until a buffer overflow from each of the queue lengths and the data inflow amount for each of the queues, computes a reciprocal ratio of the remaining time for each of the queues, and determines that a product of the ratio and an amount of data per unit time which can be output from an output port is a data output amount of each of the queues.

In addition, a scheduling method according to the present invention includes:
acquiring queue lengths of a plurality of queues;
acquiring a data inflow amount to each of the queues;
calculating a remaining time until a buffer overflow from each of the queue lengths and the data inflow amount for each of the queues;
computing a reciprocal ratio of the remaining time for each of the queues; and
determining that a product of the ratio and an amount of data per unit time which can be output from an output port is a data output amount of each of the queues.

In the scheduling method of the communication apparatus, an output amount of a queue is determined by reflecting a packet inflow amount to each queue (buffer), and thus the output amount can be set in compliance with a change in inflow amount. Further, in the scheduling method of the communication apparatus, the output amount of a queue is determined by also reflecting a remaining queue length, and thus the buffer overflow does not easily occur. Hence, the present invention can provide the communication apparatus and the scheduling method that can inhibit the buffer overflow even in a state where inflow traffic to each of the plurality of queues changes from moment to moment.

The present invention is a program for causing a computer to operate as the communication apparatus. A data collection apparatus of the present invention can also be realized by a computer and a program, and the program can be recorded in a recording medium or provided through a network.

Note that the respective inventions described above can be combined where possible.

### Advantageous Effects of Invention

The present invention can provide a communication apparatus, a scheduling method, and a program which can inhibit a buffer overflow, even in a state where inflow traffic to each of a plurality of queues changes from moment to moment.

### BRIEF DESCRIPTION OF DRAWINGS

FIG. 1 is a diagram illustrating a communication apparatus according to the present invention.

FIG. 2 is a flowchart illustrating a scheduling method according to the present invention.

FIG. 3 is a graph illustrating an effect of the present invention.

FIG. 4 is a graph illustrating an effect of the present invention.

FIG. 5 is a graph illustrating an effect of the present invention.

FIG. 6 is a graph illustrating an effect of the present invention.

FIG. 7 is a graph illustrating an effect of the present invention.

FIG. 8 is a graph illustrating an effect of the present invention.

FIG. 9 is a diagram illustrating a controller of the communication apparatus according to the present invention.

### DESCRIPTION OF EMBODIMENTS

Embodiments of the present invention will be described with reference to the accompanying drawings. The embodiments described below are examples of the present invention, and the present invention is not limited to the following embodiments. Note that components having the same reference numerals in the present description and the drawings indicate the same components.

### First Embodiment

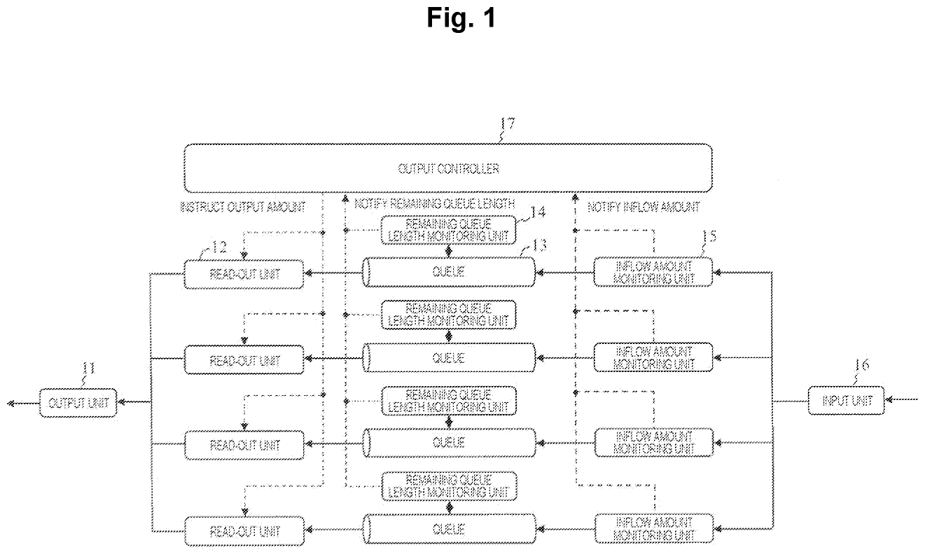

FIG. 1 is a block diagram for illustrating a communication apparatus of this embodiment. The communication apparatus includes:
a remaining queue length monitoring unit 14 that acquires queue lengths of a plurality of queues 13;
an inflow amount monitoring unit 15 that acquires a data inflow amount to each of the queues 13; and
a controller 17 that calculates a remaining time until a buffer overflow from each of the queue lengths and the data inflow amount for each of the queues 13, computes a reciprocal ratio of the remaining time for each of the queues 13, and determines that a product of the ratio and an amount of data per unit time which can be output from an output unit 11 is a data output amount of each of the queues 13.

The communication apparatus in FIG. 1 has a configuration in which the number of queues is four; however, the number of queues is not limited to four.

The communication apparatus is, for example, a router.

An input unit 16 receives a packet transmitted from the outside of the communication apparatus. The input unit 16 allocates received packets to the plurality of queues 13 for each priority rank order or for each type of application software.

The inflow amount monitoring unit 15 monitors how much data (packets) flows into each queue 13.

The remaining queue length monitoring unit 14 monitors remaining lengths of the respective queues 13 (queue lengths).

The read-out unit 12 reads out data from the queue 13 in compliance with an output amount notified of by the controller 17.

The output unit 11 collects data output from the respective queues 13 and outputs the data to the outside of the communication apparatus.

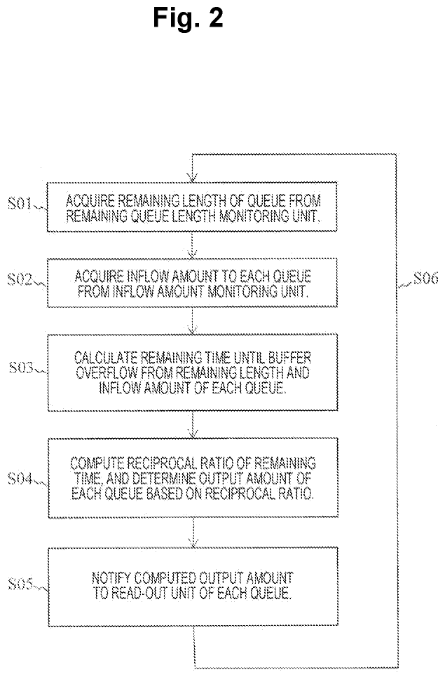

The controller 17 acquires information from the inflow amount monitoring unit 15 and the remaining queue length monitoring unit 14 for each predetermined control cycle and determines output amounts of all of the queues 13 as illustrated in FIG. 2.

Step S01: Current remaining lengths (queue length) of the respective queues 13 are acquired from the remaining queue length monitoring unit 14.

Step S02: Data inflow amounts to the respective queues 13 are acquired from the inflow amount monitoring unit 15.

Step S03: A remaining time until a buffer overflow of each of the queues 13 is calculated from each of the acquired queue lengths and the data inflow amount.

Step S04: A reciprocal ratio of the time until the buffer overflow of each of the queues 13 is computed, and a product of the ratio and an amount of data that can be output is determined as an output amount from each of the queues 13. Here, the “amount of data that can be output” is an amount of data per unit time which can be output from the output unit 11. For example, when an output bandwidth of the output unit 11 is set to 1 Gbps, and the entire output bandwidth can be used, the amount of data that can be output is 1 Gbps; however, when only 500 Mbps can be used due to bandwidth control or the like, 500 Mbps is the amount of data that can be output.

Step S05: The output amount of each of the queues is notified to the read-out unit 12.

Step S06: Steps S01 to S05 described above are repeated at predetermined intervals (control cycle).

### Computation Example of Step S04

When there are three queues, and times until buffer overflows of the respective queues are assumed to be 15 msec, 20 msec, and 50 msec, a reciprocal ratio thereof is 1/15:1/20:1/50≈7:3:2. When the amount that can be output is 1, the output amounts per unit time from the three queues are 7/12 (˜ 0.58), 3/12 (˜ 0.25), and 2/12 (˜ 0.17).

### EXAMPLES

In this communication apparatus, the data inflow amount to each queue 13, the queue length of each queue, and a change in data output amount are described. An amount of packets (queue length) as an initial value which is accumulated in each queue is 10 for a queue 13#1, 8 for a queue 13#2, 5 for a queue 13#3, and 5 for a queue 13#4. A maximum value of the queue length is 20 for all of the queues. In addition, the amount that can be output is 8.

### Example 1

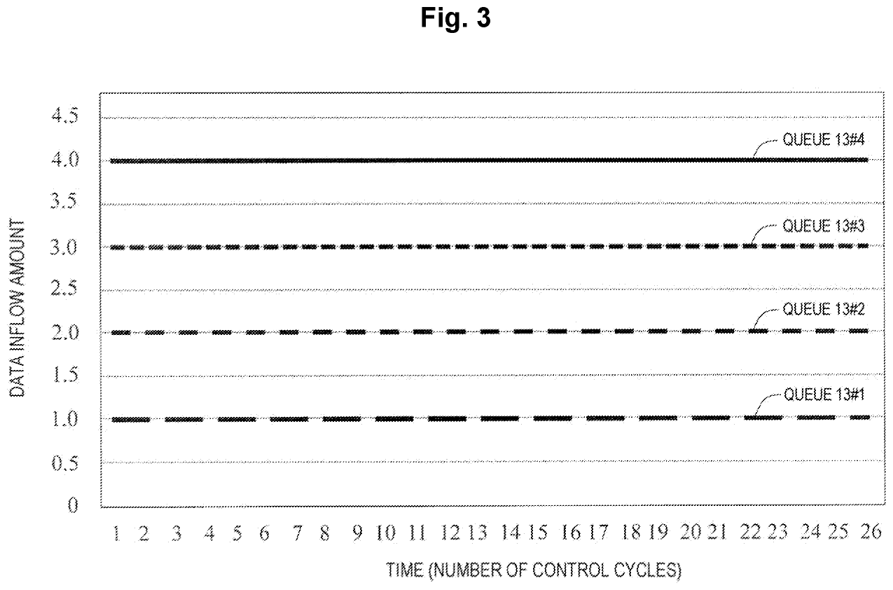

In this example, a case where data inflow amounts to the respective queues 13 are equal as illustrated in FIG. 3 is described. In FIG. 3, the horizontal axis represents time (number of control cycles), and the vertical axis represents a data inflow amount. The data inflow amounts are 1 for the queue 13#1, 2 for the queue 13#2, 3 for the queue 13#3, and 4 for the queue 13#4.

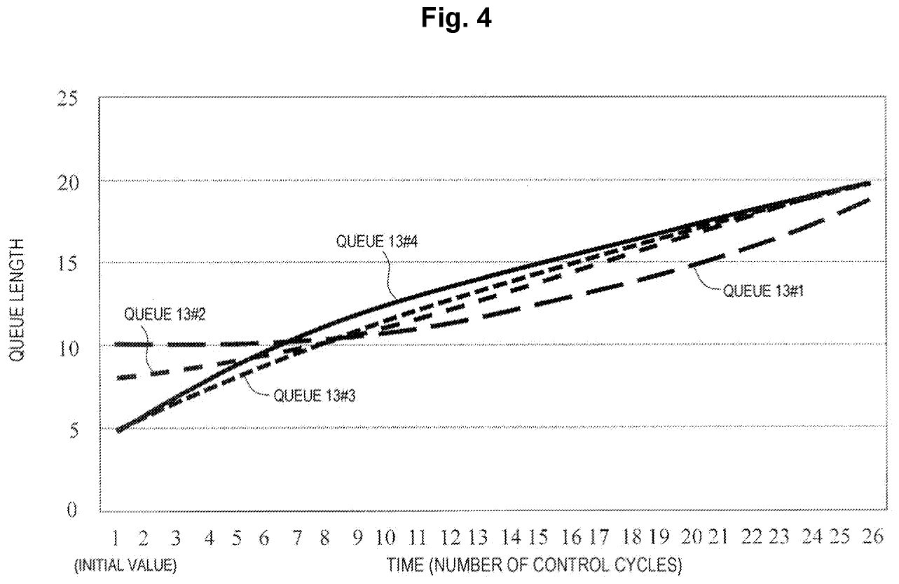

FIG. 4 is a graph illustrating the queue lengths of the respective queues 13, when this scheduling control is performed. In FIG. 4, the horizontal axis represents time (number of control cycles), and the vertical axis represents a queue length. Regardless of a difference in inflow pattern from the graph, output adjustment for reaching accumulation to the maximum value in all of the queues can be performed, and thus the packet loss does not easily occur.

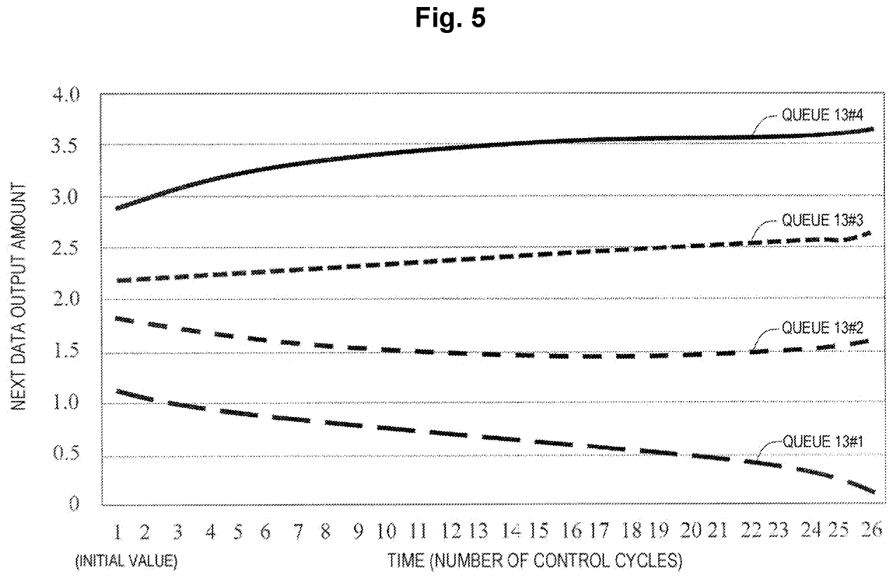

FIG. 5 is a graph illustrating the data output amount from the respective queues 13, when this scheduling control is performed. In FIG. 5, the horizontal axis represents time (number of control cycles), and the vertical axis represents a data output amount of the next cycle. The data output amount is obtained depending on the data inflow amount.

### Example 2

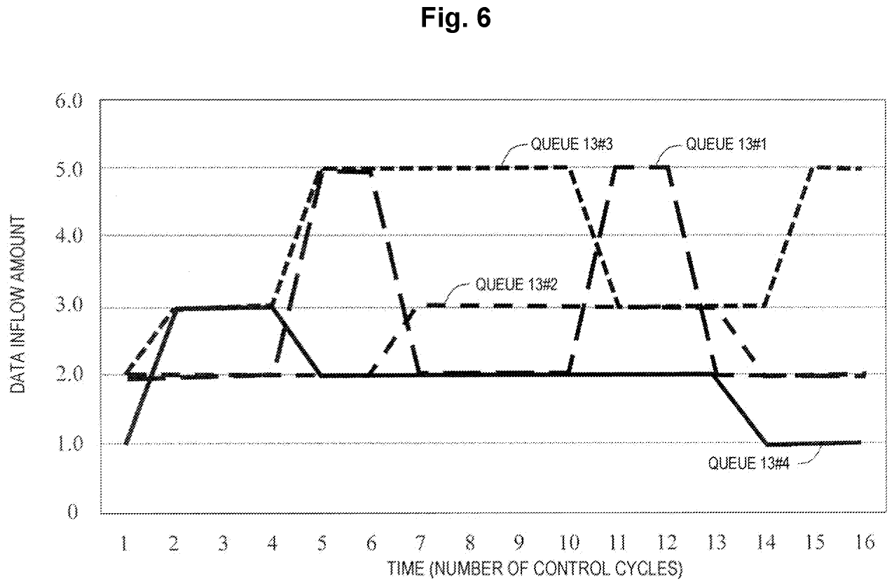

In this example, a case where data inflow amounts to the respective queues 13 change from moment to moment as illustrated in FIG. 6 is described. In FIG. 6, the horizontal axis represents time (number of control cycles), and the vertical axis represents a data inflow amount.

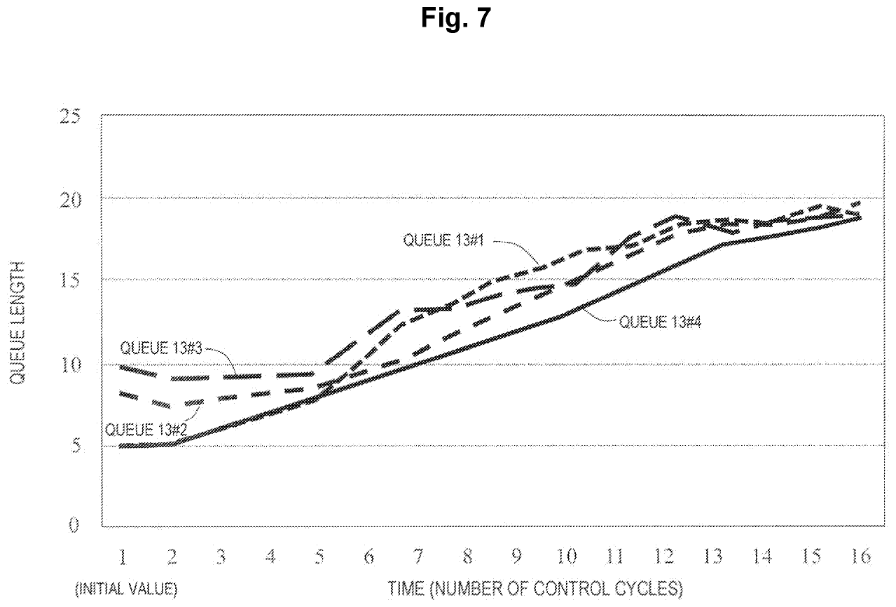

FIG. 7 is a graph illustrating the queue lengths of the respective queues 13, when this scheduling control is performed. In FIG. 7, the horizontal axis represents time (number of control cycles), and the vertical axis represents a queue length. Regardless of a difference in inflow pattern from the graph, output adjustment for reaching accumulation to the maximum value in all of the queues can be performed, and thus the packet loss does not easily occur.

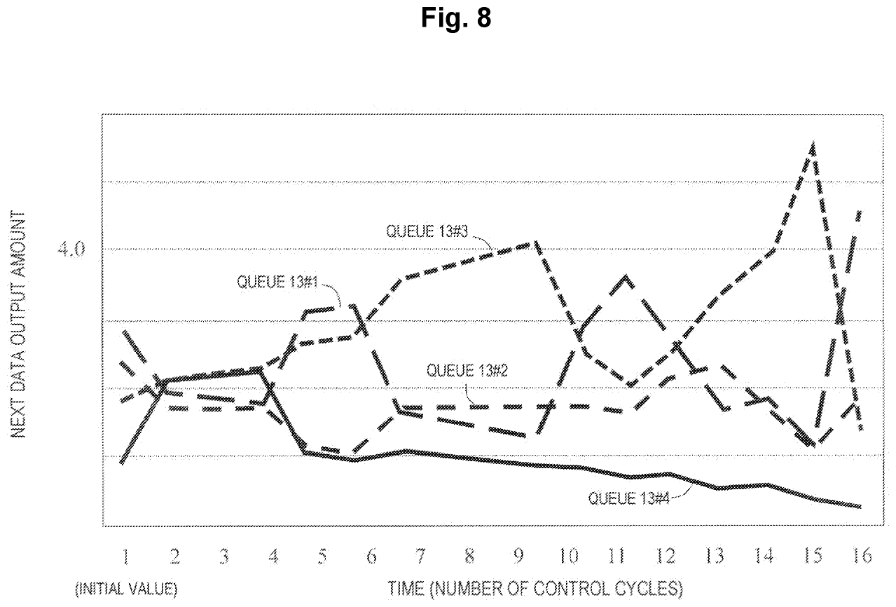

FIG. 8 is a graph illustrating the data output amount from the respective queues 13, when this scheduling control is performed. In FIG. 8, the horizontal axis represents time (number of control cycles), and the vertical axis represents a data output amount of the next cycle. The data output amount can be set in compliance with a change in data inflow amount.

### Second Embodiment

The controller 17 can also be realized by a computer and a program, and the program can be recorded in a recording medium or provided through a network.

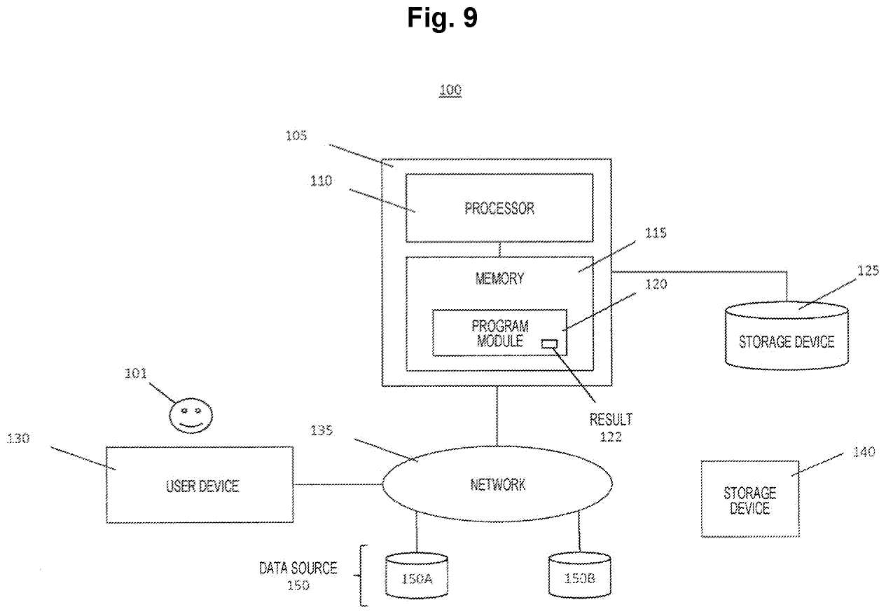

FIG. 9 illustrates a block diagram of a system 100. The system 100 includes a computer 105 connected to a network 135.

The network 135 is a data communication network. The network 135 may be a private network or a public network, and may include any or all of (a) a personal area network, for example, covering a room, (b) a local area network, for example, covering a building, (c) a campus area network, for example, covering a campus, (d) a metropolitan area network, for example, covering a city, (e) a wide area network, for example, covering an area connected across boundaries of cities, rural areas, or countries, and (f) the Internet. Communication is performed by an electronic signal and an optical signal via the network 135.

The computer 105 includes a processor 110 and a memory 115 connected to the processor 110. In the present specification, the computer 105 is represented as a standalone device. On the other hand, the computer is not limited thereto, and may be connected to other devices (not illustrated) in a distributed processing system.

The processor 110 is an electronic device including a logic circuitry that responds to a command and executes the command.

The memory 115 is a tangible computer-readable storage medium in which a computer program is encoded. In this regard, the memory 115 stores data and commands, that is, program codes, that are readable and executable by the processor 110 to control operation of the processor 110. The memory 115 can be realized by a random access memory (RAM), a hard drive, a read-only memory (ROM), or a combination thereof. One of the components of the memory 115 is a program module 120.

The program module 120 includes commands for controlling the processor 110 to perform processes described in the present specification. In the present specification, although it is described that operation is executed by the computer 105, a method, a process, or a sub-process thereof, the operation is actually executed by the processor 110.

In the present specification, the term “module” is used to refer to a functional operation that may be embodied as one of a stand-alone component or an integrated configuration of a plurality of sub-components. Thus, the program module 120 can be implemented as a single module or as a plurality of modules that operate in cooperation with each other. Further, in the present specification, although the program module 120 is described as being installed in the memory 115 and thus implemented in software, the program module 120 can be implemented in any of hardware (for example, an electronic circuit), firmware, software, or a combination thereof.

Although the program module 120 is illustrated as already being loaded into the memory 115, the program module 120 may be configured to be provided on a storage device 140 to be subsequently loaded into the memory 115. The storage device 140 is a tangible computer-readable storage medium that stores the program module 120. Examples of the storage device 140 include a compact disc, a magnetic tape, a read-only memory, an optical storage medium, a hard drive or a memory unit including a plurality of parallel hard drives, and a Universal Serial Bus (USB) flash drive. Alternatively, the storage device 140 may be a random access memory or another type of electronic storage device provided in a remote storage system (not illustrated) and connected to the computer 105 via the network 135.

The system 100 further includes a data source 150A and a data source 150B which are collectively referred to as a data source 150 in the present specification and are communicatively connected to the network 135. In practice, the data source 150 may include any number of data sources, that is, one or more data sources. The data source 150 may include unstructured data and may include social media.

The system 100 further includes a user device 130 operated by a user 101 and connected to the computer 105 via the network 135. Examples of the user device 130 include an input device, such as a keyboard or a voice recognition subsystem, for enabling the user 101 to input information and command selections to the processor 110. The user device 130 further includes an output device such as a display device, a printer, or a speech synthesizer. A cursor control unit such as a mouse, a trackball, or a touch-sensitive screen allows the user 101 to manipulate a cursor on the display device to input further information and command selections to the processor 110.

The processor 110 outputs a result 122 of execution of the program module 120 to the user device 130. Alternatively, the processor 110 can provide the output to a storage device 125 such as a database or a memory or to a remote device (not illustrated) via the network 135.

For example, a program that performs processing illustrated in the flowchart of FIG. 2 may be used as the program module 120. The system 100 can be operated as the controller 17.

The term “include . . . ” or “including . . . ” specifies that the mentioned features, integers, steps, or components are present, but should be understood as not excluding the presence of one or more other features, integers, steps, or components, or groups thereof. The terms “a” and “an” are indefinite articles for an object and therefore do not exclude embodiments including a plurality of objects.

### OTHER EMBODIMENTS

Note that the present invention is not limited to the above embodiments, and various modifications can be made without departing from the gist of the present invention. In short, the present invention is not limited to the above embodiments, and in the implementation stage, the components may be modified and embodied without departing from the gist of the present invention.

In addition, various inventions can be made by appropriately combining a plurality of components disclosed in the above embodiments. For example, some components may be deleted from all the components illustrated in the embodiments. Further, components in different embodiments may be appropriately combined.

### REFERENCE SIGNS LIST

11 Output unit
12 Read-out unit
13 Queue
14 Remaining queue length monitoring unit
15 Inflow amount monitoring unit
16 Input unit
17 Controller
100 System
101 User
105 Computer
110 Processor
115 Memory
120 Program module
122 Result
125 Storage device
130 User device
135 Network
140 Storage device
150 Data source

1. A communication apparatus comprising:
a remaining queue length monitoring unit that acquires queue lengths of a plurality of queues;
an inflow amount monitoring unit that acquires a data inflow amount to each of the queues; and
a controller that calculates a remaining time until a buffer overflow from the queue lengths and the data inflow amount for each of the queues, computes a reciprocal ratio of the remaining time for each of the queues, and determines that a product of the ratio and an amount of data per unit time which can be output from an output port is a data output amount of each of the queues.

2. A scheduling method comprising:
acquiring queue lengths of a plurality of queues;
acquiring a data inflow amount to each of the queues;
calculating a remaining time until a buffer overflow from the queue lengths and the data inflow amount for each of the queues;
computing a reciprocal ratio of the remaining time for each of the queues; and
determining that a product of the ratio and an amount of data per unit time which can be output from an output port is a data output amount of each of the queues.

3. A program for causing a computer to operate as the communication apparatus according to claim 1.
